(19) United States
(12) Patent Application Publication
(10) Pub. No.: US 2026/0264672 A1
(43) Pub. Date: Sep. 10, 2026

(54) DRIVING ASSISTANCE APPARATUS

(71) Applicant: TOYOTA JIDOSHA KABUSHIKI KAISHA, Aichi (JP)

(72) Inventor: Masami NAGANO, Seto-shi (JP)

(21) Appl. No.: 19/548,978

(22) Filed: Feb. 25, 2026

(30) Foreign Application Priority Data
Mar. 4, 2025 (JP) 2025-033462

(51) Int. Cl. B60W 30/09; B60W 50/00

(52) U.S. Cl. CPC B60W 30/09; B60W 50/0098; B60W 2050/0094; B60W 2540/221; B60W 2710/20; B60W 2720/106

(57) ABSTRACT

A driving assistance apparatus executes, when a collision risk of the vehicle colliding with an object is high, either steering control for changing a traveling direction of a vehicle in order to reduce the collision risk, or deceleration control for decelerating the vehicle in order to reduce the collision risk. The driving assistance apparatus is configured to, when a steering priority condition that an occupant whose height is equal to or less than a threshold is on board the vehicle is satisfied, execute the steering control with priority over the deceleration control.

### TECHNICAL FIELD

The present disclosure relates to a driving assistance apparatus configured to execute either steering control or deceleration control in order to reduce a collision risk of a vehicle colliding with an object.

### BACKGROUND

Conventionally, a driving assistance apparatus configured to execute either steering control or deceleration control in order to reduce a collision risk when the collision risk is high has been known. For example, a driving assistance apparatus described in Patent Document 1 (hereinafter referred to as “the conventional apparatus”) reduces a deceleration in deceleration control when at least one of the occupied seats is without a fastened seatbelt, as compared to when seatbelts are fastened on all occupied seats.

Patent Document 1: Japanese Patent Application Laid-Open No. 2015-205648

### SUMMARY

A low-height occupant (for example, a child), even when wearing a seatbelt, is exposed to a higher risk to the body (hereinafter referred to as “body risk”) due to the execution of the deceleration control. Since the conventional apparatus executes the deceleration control even when the low-height occupant is on board, the body risk cannot be reduced.

The present disclosure is made to address the above problem. That is, one of the objects of the present disclosure is to provide a driving assistance apparatus capable of executing vehicle control for reducing the collision risk, which can also reduce the body risk of the low-height occupant.

A driving assistance apparatus (hereinafter referred to as “the present apparatus”) configured to execute, when a collision risk of the vehicle colliding with an object is high, either steering control for changing a traveling direction of a vehicle in order to reduce the collision risk, or deceleration control for decelerating the vehicle in order to reduce the collision risk (step 410, step 430).

The driving assistance apparatus is configured to, when a steering priority condition that an occupant whose height is equal to or less than a threshold is on board the vehicle is satisfied (step 210 “Yes”, step 220, step 310 “No”, step 335 “No”), execute the steering control with priority over the deceleration control (step 320, step 345).

According to the present apparatus, when the occupant whose height is equal to or less than the threshold is on board the vehicle, the steering priority condition is satisfied and the steering control is executed with priority over the deceleration control. Accordingly, when the steering priority condition is satisfied, the possibility that the deceleration control is executed can be reduced, and thus the body risk to the low-height occupant can be reduced.

### BRIEF DESCRIPTION OF THE DRAWINGS

FIG. 1 is a schematic system configuration diagram of a driving assistance apparatus according to an embodiment of the present disclosure.

FIG. 2 is a flowchart illustrating a steering priority condition determination routine executed by a CPU of an ECU shown in FIG. 1.

FIG. 3 is a flowchart illustrating an execution determination routine executed by the CPU of the ECU shown in FIG. 1.

FIG. 4 is a flowchart illustrating a vehicle control routine executed by the CPU of the ECU shown in FIG. 1.

### DETAILED DESCRIPTION

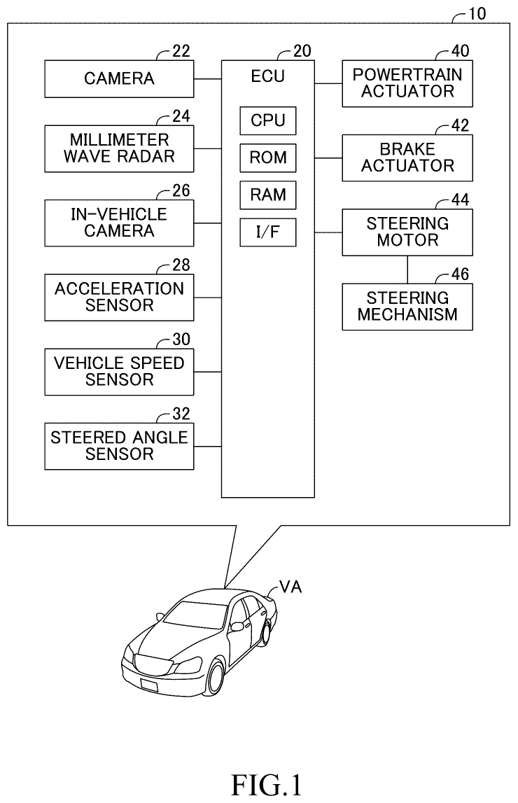

A driving assistance apparatus 10 according to an embodiment of the present disclosure (hereinafter, referred to as “the present apparatus 10”) is applied to a vehicle VA and comprises components shown in FIG. 1. In the present specification, an “ECU 20” is an electronic control unit having a microcomputer as a main component. The ECU 20 is also referred to as a control unit, a controller and a computer. The microcomputer includes a CPU (processor), a ROM, a RAM and an interface (I/F), etc. Functions realized by the ECU 20 may be realized by multiple ECUs.

A camera 22 acquires forward image data by capturing an area in front of the vehicle VA. A millimeter-wave radar 24 receives a reflected wave of a millimeter wave transmitted forward from the vehicle VA and reflected by an object, and acquires radar data. The radar data is data relating to a position of the object relative to the vehicle VA and a relative speed of the object with respect to the vehicle VA.

The ECU 20 acquires the forward image data from the camera 22 and acquires the radar data from the millimeter-wave radar 24. The ECU 20 recognizes an object in front of the vehicle VA based on the forward image data and the radar data.

An in-vehicle camera 26 acquires in-vehicle image data by capturing an area inside a passenger compartment of the vehicle VA. The ECU 20 acquires the in-vehicle image data from the in-vehicle camera 26.

An acceleration sensor 28 measures a longitudinal acceleration G of the vehicle VA. The acceleration G in the forward direction of the vehicle VA is a positive value, and the acceleration G in the rearward direction of the vehicle VA is a negative value. A vehicle speed sensor 30 measures a vehicle speed Vs representing a speed of the vehicle VA. A steered angle sensor 32 acquires a steered angle θ of steered wheels of the vehicle VA. The ECU 20 acquires measurement values from the sensors 28 to 32.

A powertrain actuator 40 changes a driving force generated by a drive unit (e.g., an internal combustion engine and/or an electric motor) of the vehicle VA. A brake actuator 42 changes a braking force applied to the vehicle VA. A steering motor 44 is incorporated in a steering mechanism 46. The steering mechanism 46 is a mechanism for steering the steered wheels in response to a steering operation of a steering wheel (not shown) by the driver. Furthermore, the steering motor 44 applies an automatic steering torque for changing the steered angle θ (a traveling direction of the vehicle VA) of the steered wheels in accordance with an instruction from the ECU 20.

### Vehicle Control

When a collision risk of the vehicle VA colliding with an object is high, the ECU 20 executes vehicle control for reducing the collision risk. Specifically, the ECU 20 executes either steering control or deceleration control as the vehicle control.

In the steering control, the ECU 20 changes the traveling direction of the vehicle VA to reduce the collision risk. Specifically, the ECU 20 controls the steering motor 44 so that the vehicle VA travels along an avoidance route to pass through an avoidance space beside the object.

In the deceleration control, the ECU 20 decelerates the vehicle VA to reduce the collision risk. Specifically, the ECU 20 controls the powertrain actuator 40 and the brake actuator 42 such that the acceleration G matches a predetermined negative target acceleration Gtgt.

When both a “steering control condition” and a “deceleration control condition” described later are satisfied, the ECU 20 executes the deceleration control. When only the steering control condition is satisfied, the ECU 20 executes the steering control, and when only the deceleration control condition is satisfied, the ECU 20 executes the deceleration control. The steering control condition is an execution condition for the steering control, and the deceleration control condition is an execution condition for the deceleration control.

### Steering Control Conditions

The steering control condition is satisfied when all of the following conditions S1 to S4 are satisfied.

Condition S1: A TTC is equal to or less than a first threshold time T1th.

TTC stands for “Time To Collision” and represents the time until the vehicle VA collides with the object. The ECU 20 acquires the TTC by dividing a distance between the vehicle VA and the object by the relative speed of the object. The TTC is an index value representing the collision risk. The smaller the TTC, the higher the collision risk. In other words, the condition S1 is a condition that the collision risk is equal to or greater than a first threshold risk.

Condition S2: An overlap ratio Lp is equal to or less than a first threshold overlap ratio Lp1th.

The overlap ratio Lp represents a degree of overlap in the vehicle-width direction between the vehicle VA and the object having the minimum TTC. The ECU 20 acquires the overlap ratio Lp based on the forward image data and the radar data.

Condition S3: The vehicle speed Vs is equal to or less than a first threshold vehicle speed Vs1th.

Condition S4: an avoidance space exists beside the object having the minimum TTC.

The avoidance space is a space having a width greater than the width of the vehicle VA. The ECU 20 determines whether or not the avoidance space exists based on the forward image data and the radar data.

### Deceleration Control Condition

The deceleration control condition is satisfied when the TTC is equal to or less than the first threshold time T1th. In other words, the deceleration control condition is satisfied when the collision risk is equal to or greater than the first threshold risk.

### Overview of Operation

The ECU 20 determines whether or not a steering priority condition, in which an occupant whose height is equal to or less than a threshold is on board the vehicle VA, is satisfied. When the steering priority condition is satisfied, the ECU 20 executes the steering control with priority over the deceleration control. For example, when both the steering control condition and the deceleration control condition are satisfied, the ECU 20 executes the steering control. As a result, the body risk to a low-height occupant can be reduced.

Furthermore, when the steering priority condition is satisfied, the ECU 20 makes it easier for the steering control condition to be satisfied (relaxes the steering control condition) by using a relaxed steering control condition. This allows the ECU 20 to execute the steering control with priority over the deceleration control.

The relaxed steering control condition is satisfied when all of the following conditions S1′ to S3′ and the above condition S4 are satisfied.

Condition S1′: The TTC is equal to or less than a second threshold time T2th, which is greater than the first threshold time T1th. Condition S1′ is a condition that the collision risk is equal to or greater than a second threshold risk, which is smaller than the first threshold risk.

Condition S2′: The overlap ratio Lp is equal to or less than a second threshold overlap ratio Lp2th, which is greater than the first threshold overlap ratio Lp1th.

Condition S3′: The vehicle speed Vs is equal to or less than a second threshold vehicle speed Vs2th, which is greater than the first threshold vehicle speed Vs1th.

The non-relaxed steering control condition may be referred to as a “normal steering control condition,” and the relaxed steering control condition may be referred to as a “relaxed steering control condition.”

Accordingly, when the steering priority condition is satisfied, it becomes easier for the steering control condition to be satisfied. Therefore, the possibility that both the steering control condition and the deceleration control condition are satisfied increases, and when both conditions are satisfied while the steering priority condition is satisfied, the steering control is executed, so that the possibility that steering control is executed with priority is increased. Furthermore, in the relaxed steering control condition, the TTC is compared with the second threshold time T2th, which is greater than the first threshold time T1th. Therefore, the relaxed steering control condition may be satisfied at an earlier timing than the deceleration control condition, so that there is also a possibility that only the steering control condition is satisfied. As a result, the possibility that steering control is executed with priority can be increased.

### Specific Operation

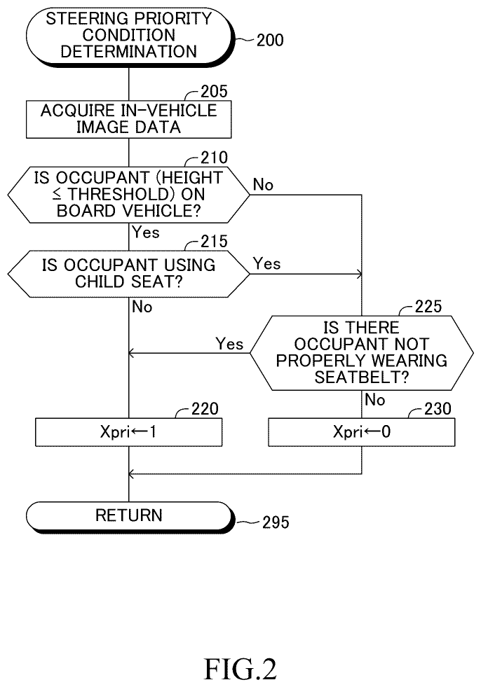

The CPU of the ECU 20 executes routines shown in flowcharts of FIGS. 2 to 4 each time a predetermined time period elapses.

### Steering Priority Condition Determination Routine

When an appropriate timing comes, the CPU starts a process from step 200 in FIG. 2 and executes steps 205 and 210.

Step 205: The CPU acquires the in-vehicle image data from the in-vehicle camera 26.

Step 210: The CPU determines, based on the in-vehicle image data, whether or not the occupant whose height is equal to or less than a threshold is on board the vehicle VA.

For example, the CPU determines, based on the in-vehicle image data, whether or not there is the occupant whose head is positioned below a predetermined position of a seat back of the vehicle VA. If there is such an occupant, the CPU determines that the occupant whose height is equal to or less than the threshold is on board the vehicle VA.

When the occupant whose height is equal to or less than the threshold is on board the vehicle VA, the CPU makes a “Yes” determination at step 210, and the process proceeds to step 215. At step 215, the CPU determines, based on the in-vehicle image data, whether or not the occupant whose height is equal to or less than the threshold is using a child seat.

When the occupant whose height is equal to or less than the threshold is not using the child seat, the steering priority condition is satisfied. In this case, the CPU makes a “No” determination at step 215, and the process proceeds to step 220. At step 220, the CPU sets a steering priority flag Xpri to “1.” Thereafter, the process proceeds to step 295, and the CPU temporarily ends this routine.

The steering priority flag Xpri is set to “1” when the steering priority condition is satisfied, and is set to “0” when the steering priority condition is not satisfied. The steering priority flag Xpri is set to “0” in an initialization routine. The CPU executes the initialization routine when an ignition key switch (not shown) of the vehicle VA is switched from an OFF position to an ON position.

When no occupant whose height is equal to or less than the threshold is on board the vehicle VA, the CPU makes a “No” determination at step 210, and the process proceeds to step 225. When the occupant whose height is equal to or less than the threshold is using the child seat, the CPU makes a “Yes” determination at step 215, and the process proceeds to step 225.

At step 225, the CPU determines, based on the in-vehicle image data, whether or not there is an occupant not properly wearing a seatbelt. Specifically, when there is an occupant not wearing a seatbelt, an occupant with a twisted seatbelt, or an occupant whose seatbelt is not positioned properly, the CPU determines that there is an occupant not properly wearing a seatbelt.

When there is an occupant not properly wearing a seatbelt, the steering priority condition is satisfied. In this case, the CPU makes a “Yes” determination at step 225, and the process proceeds to step 220. On the other hand, when there is no occupant not properly wearing a seatbelt, the steering priority condition is not satisfied. In this case, the CPU makes a “No” determination at step 225, and the process proceeds to step 230. At step 230, the CPU sets the steering priority flag Xpri to “0.” Thereafter, the process proceeds to step 295.

### Execution Determination Routine

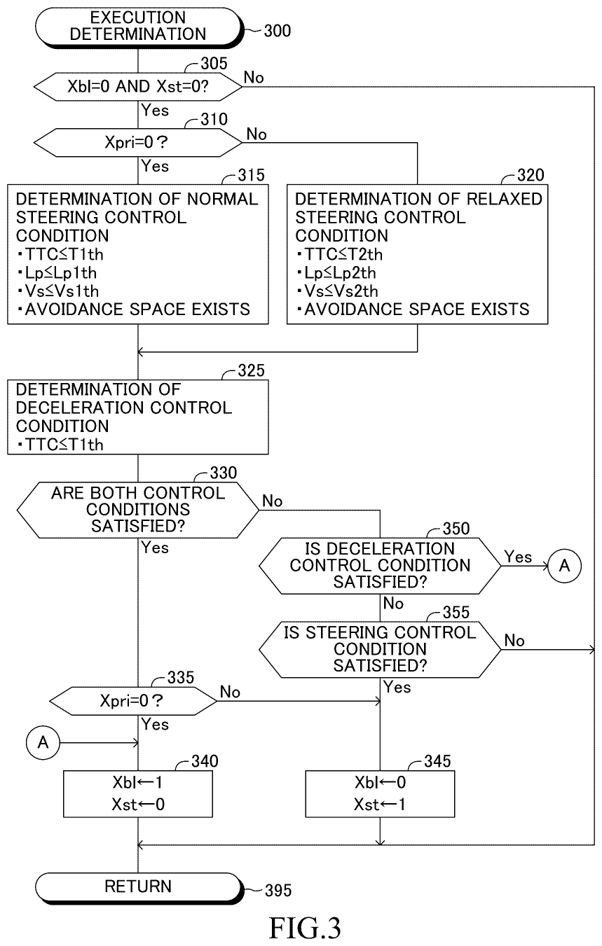

When an appropriate timing comes, the CPU starts a process from step 300 in FIG. 3, and the process proceeds to step 305. At step 305, the CPU determines whether or not both a deceleration flag Xbl and a steering flag Xst are “0.”

The deceleration flag Xbl is set to “1” when the deceleration control is executed, and is set to “0” when the deceleration control is not executed. The steering flag Xst is set to “1” when the steering control is executed, and is set to “0” when the steering control is not executed. The deceleration flag Xbl and the steering flag Xst are set to “0” in the initialization routine.

When both the deceleration flag Xbl and the steering flag Xst are “0,” the CPU makes a “Yes” determination at step 305, and the process proceeds to step 310. At step 310, the CPU determines whether or not the steering priority flag Xpri is “0.”

When the steering priority flag Xpri is “0,” the CPU makes a “Yes” determination at step 310, and the process proceeds to step 315. At step 315, the CPU determines whether or not the normal steering control condition is satisfied.

On the other hand, when the steering priority flag Xpri is “1,” the CPU makes a “No” determination at step 310, and the process proceeds to step 320. At step 320, the CPU determines whether or not the relaxed steering control condition is satisfied.

After executing step 315 or step 320, the CPU executes steps 325 and 330.

Step 325: The CPU determines whether or not the deceleration control condition is satisfied.

Step 330: The CPU determines whether both the steering control condition and the deceleration control condition are satisfied.

When both the steering control condition and the deceleration control condition are satisfied, the CPU makes a “Yes” determination at step 330, and the process proceeds to step 335. At step 335, the CPU determines whether or not the steering priority flag Xpri is “0.”

When the steering priority flag Xpri is “0,” the CPU makes a “Yes” determination at step 335, and the process proceeds to step 340. At step 340, the CPU sets the deceleration flag Xbl to “1” and sets the steering flag Xst to “0.” Thereafter, the process proceeds to step 395, and the CPU temporarily ends this routine.

When the steering priority flag Xpri is “1,” the CPU makes a “No” determination at step 335, and the process proceeds to step 345. At step 345, the CPU sets the deceleration flag Xbl to “0” and sets the steering flag Xst to “1.” Thereafter, the process proceeds to step 395.

If at least one of the steering control condition and the deceleration control condition is not satisfied when the process proceeds to step 330, the CPU makes a “No” determination at step 330, and the process proceeds to step 350. At step 350, the CPU determines whether or not the deceleration control condition is satisfied.

When the deceleration control condition is satisfied, the CPU makes a “Yes” determination at step 350, and the process proceeds to step 340. When the deceleration control condition is not satisfied, the CPU makes a “No” determination at step 350, and the process proceeds to step 355. At step 355, the CPU determines whether or not the steering control condition is satisfied.

When the steering control condition is satisfied, the CPU makes a “Yes” determination at step 355, and the process proceeds to step 345. When the steering control condition is not satisfied, the CPU makes a “No” determination at step 355, and the process proceeds to step 395.

### Vehicle Control Routine

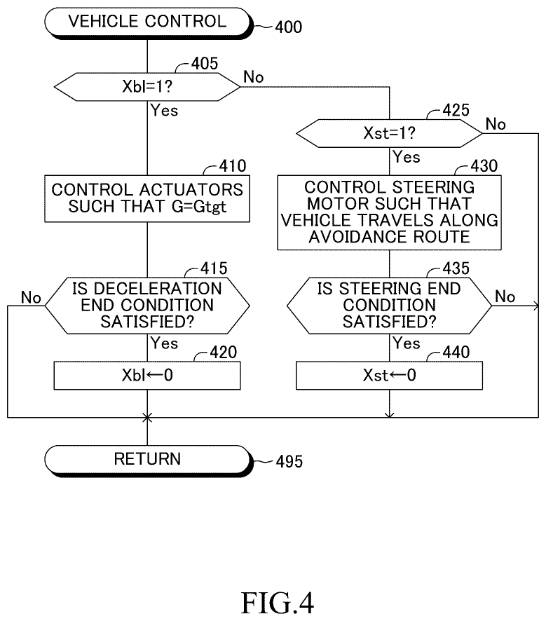

When an appropriate timing comes, the CPU starts a process from step 400 in FIG. 4, and the process proceeds to step 405. At step 405, the CPU determines whether or not the deceleration flag Xbl is “1.”

When the deceleration flag Xbl is “1,” the CPU makes a “Yes” determination at step 405, and executes steps 410 and 415.

Step 410: The CPU controls the powertrain actuator 40 and the brake actuator 42 such that the acceleration G matches a predetermined negative target acceleration Gtgt.

Step 415: the Cpu Determines Whether or Not a Deceleration End Condition Is satisfied.

As one example, when a state in which the vehicle VA is stopped continues for a predetermined time period or longer, or when the collision risk has disappeared, the CPU determines that the deceleration end condition is satisfied.

When the deceleration end condition is not satisfied, the CPU makes a “No” determination at step 415, and the process proceeds to step 495. At step 495, the CPU temporarily ends this routine. When the deceleration end condition is satisfied, the CPU makes a “Yes” determination at step 415, and the process proceeds to step 420. At step 420, the CPU sets the deceleration flag Xbl to “0.” Thereafter, the process proceeds to step 495.

When the process has proceeded to step 405 and the deceleration flag Xbl is “0,” the CPU makes a “No” determination at step 405, and the process proceeds to step 425. At step 425, the CPU determines whether or not the steering flag Xst is “1.”

When the steering flag Xst is “0,” the CPU makes a “No” determination at step 425, and the process proceeds to step 495. On the other hand, when the steering flag Xst is “1,” the CPU makes a “Yes” determination at step 425, and executes steps 430 and 435.

### Step 430: the Cpu Controls the Steering Motor 44 Such That the Vehicle Va

travels along the avoidance route.

Step 435: The CPU determines whether or not a steering end condition is satisfied.

As one example, when the vehicle VA has passed through the avoidance space, the CPU determines that the steering end condition is satisfied.

When the steering end condition is not satisfied, the CPU makes a “No” determination at step 435, and the process proceeds to step 495. When the steering end condition is satisfied, the CPU makes a “Yes” determination at step 435, and the process proceeds to step 440. At step 440, the CPU sets the steering flag Xst to “0.” Thereafter, the process proceeds to step 495.

As described above, when the steering priority condition is satisfied, the present apparatus 10 executes the steering control with priority. Accordingly, since the possibility that the deceleration control is executed as the vehicle control is reduced, it is possible to reduce the possibility of an increase in the body risk to the occupant whose height is equal to or less than the threshold and to the occupant not properly wearing the seatbelt.

### Modified Example

In the above embodiment, when the steering priority condition is satisfied, the ECU 20 executes the steering control when both the steering control condition and the deceleration control condition are satisfied, and also makes it easier for the steering control condition to be satisfied. However, when the steering priority condition is satisfied, the ECU 20 may execute the steering control when both the steering control condition and the deceleration control condition are satisfied, without making it easier for the steering control condition to be satisfied.

Furthermore, when the ECU 20 makes it easier for the steering control condition to be satisfied, it is sufficient to perform at least one of the following: using the above condition S1′ in place of the above condition S1, using the above condition S2′ in place of the above condition S2, and using the above condition S3′ in place of the above condition S3.

In the above embodiment, the TTC is used as the index value representing the collision risk, but the index value is not limited to the TTC. For example, the distance between the vehicle VA and the object may be used as the index value. When the distance is equal to or less than a threshold distance, the ECU 20 determines that the collision risk is high.

In the above embodiment, the ECU 20 determines that the steering priority condition is satisfied when the occupant whose height is equal to or less than the threshold is on board the vehicle VA (step 210:“Yes”) and the occupant is not using a child seat (step 215:“No”). However, the ECU 20 may determine that the steering priority condition is satisfied when the occupant whose height is equal to or less than the threshold is on board the vehicle VA, even if the occupant is using a child seat.

Furthermore, the present apparatus 10 may comprise at least one of the camera 22 and the millimeter-wave radar 24.

The first threshold time T1th used for determining the steering control condition may be set to a value greater than the first threshold time T1th used for determining the deceleration control condition. In other words, the first threshold risk used for determining the steering control condition may be set to a value smaller than the first threshold risk used for determining the deceleration control condition. In this case, the second threshold time T2th is set to a value greater than the first threshold time T1th used for determining the steering control condition (the second threshold risk is set to a value smaller than the first threshold risk used for determining the steering control condition).

The present apparatus 10 can be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). Furthermore, the present apparatus 10 can also be applied to an autonomous driving vehicle.

What is claimed is:

1. A driving assistance apparatus configured to execute, when a collision risk of the vehicle colliding with an object is high, either steering control for changing a traveling direction of a vehicle in order to reduce the collision risk, or deceleration control for decelerating the vehicle in order to reduce the collision risk,
wherein the driving assistance apparatus is configured to, when a steering priority condition that an occupant whose height is equal to or less than a threshold is on board the vehicle is satisfied, execute the steering control with priority over the deceleration control.

2. The driving assistance apparatus according to claim 1,
wherein the driving assistance apparatus is configured to determine that the steering priority condition is satisfied even when no occupant whose height is equal to or less than the threshold is on board the vehicle, if there is an occupant not properly wearing a seatbelt.

3. The driving assistance apparatus according to claim 1,
wherein the driving assistance apparatus is configured to:
in a case where both an execution condition of the steering control and an execution condition of the deceleration control are satisfied,
execute the deceleration control without executing the steering control when the steering priority condition is not satisfied; and
execute the steering control with priority over the deceleration control by executing the steering control without executing the deceleration control, when the steering priority condition is satisfied.

4. The driving assistance apparatus according to claim 3,
wherein the driving assistance apparatus is configured to execute the steering control with priority over the deceleration control by making it easier for the steering control condition to be satisfied than when the steering priority condition is not satisfied, when the steering priority condition is satisfied.

5. The driving assistance apparatus according to claim 4,
wherein the driving assistance apparatus is configured to:
determine that the deceleration control is executable when the collision risk is equal to or greater than a threshold risk;
determine that the steering control condition is satisfied when the collision risk is equal to or greater than the threshold risk, an overlap ratio between the vehicle and the object having the collision risk equal to or greater than the threshold risk is equal to or less than a threshold overlap ratio, a vehicle speed representing a speed of the vehicle is equal to or less than a threshold vehicle speed, and an avoidance space in which the vehicle can pass exists beside the object having the collision risk equal to or greater than the threshold risk; and
when the steering priority condition is satisfied, make it easier for the steering control condition to be satisfied by performing at least one of: setting the threshold risk smaller, setting the threshold overlap ratio larger, and setting the threshold vehicle speed larger, than when the steering priority condition is not satisfied.
